(19) United States
(12) Patent Application Publication
(10) Pub. No.: US 2025/0038445 A1
(43) Pub. Date: Jan. 30, 2025

(54) MALE-FEMALE MATING TYPE ELECTRICAL CONNECTOR

(71) Applicant: KEL CORPORATION, Tokyo (JP)

(72) Inventor: Kenta YOSHIDA, Tokyo (JP)

(73) Assignee: KEL CORPORATION, Tokyo (JP)

(21) Appl. No.: 18/782,748

(22) Filed: Jul. 24, 2024

(30) Foreign Application Priority Data
Jul. 25, 2023 (JP) 2023-120680

(51) Int. Cl. H01R 13/22; H01R 12/71

(52) U.S. Cl. CPC H01R 13/22; H01R 12/716

(57) ABSTRACT

A male-female mating type electrical connector includes a plug connector PC retaining a plurality of plug-side signal contacts 80, and a receptacle connector RC retaining a plurality of receptacle-side signal contacts 50. The plug-side signal contacts 80 are each composed of an elongated plate member rectangular in cross section, and each have a plug-signal-side contacting portion 86 having a contacting face having an arcuate cross-sectional shape and protruding, and a plug-signal-side abutting portion 85 having a contacting face having an arcuate cross-sectional shape. The receptacle-side signal contacts 50 are each composed of an elongated plate member rectangular in cross section, and each have a receptacle-signal-side contacting portion 56 having a contacting face having a planar shape and protruding toward a side in which the receptacle-side signal contact 50 contacts a mating contact, and a receptacle-signal-side abutting portion 55 having a mating-contact contacting face having a planar shape.

### TECHNICAL FIELD

The present invention relates to a male-female mating type electrical connector.

### TECHNICAL BACKGROUND

Electrical connectors are used to make a signal-line or power-supply-line connection between circuit boards, between a circuit board and a cable, or between cables, and commonly known electrical connectors have a male-female mating type connection configuration. In the connection configuration using male-female mating type connectors (generally, one connector is a female connector referred to as a receptacle connector, and the other connector is a male connector referred to as a plug connector), the male and female connectors each include a signal contact connected to the signal line and a power-supply contact connected to the power-supply line, and their signal or power-supply contacts are abutted against each other to make an electrical connection (see, for example, Japanese Laid-Open Patent Publication No. 2022-178434(A)). Recently, speeding up of signal transmission via the signal line has been often demanded. In such a case, it is desired that a stab of the contact (a portion of the contact that is not used for signal transmission) have a shorter length, and shortening the stab length as much as possible is required.

Some male-female mating type connectors have a configuration (a one-point contact configuration) in which a contact of one connector is elastically deformable and is provided with a contacting portion for contacting a mating contact at its distal end portion, a contact (the mating contact) of the other connector is provided with a planar abutting portion extending in a mating direction, and a contacting portion of the contact of one connector is abutted against an abutting portion of the contact of the other connector when the male and female connectors are mated and connected to each other. The connector configured according to Japanese Laid-Open Patent Publication No. 2022-178434(A), for example, has such a configuration. In the case of such a configuration in which the contacting portion is abutted against the abutting portion at one point, namely, the so-called one-point contact configuration, a portion of the contact of one connector that is more distal than the contacting portion becomes a stab, and a portion of the contact of the other connector that is more distal than the abutting portion becomes a stab. In the case of the one-point contact configuration, it is necessary to ensure that the contacts have a sufficiently long effective mating length in order to enhance the contact reliability of the contacts, and a problem here is that the stab length tends to be longer.

Other male-female mating type connectors have a two-point connection configuration, as disclosed in Japanese Laid-Open Patent Publication No. H04-269478 and Japanese Laid-Open Patent Publication No. 2015-35300, for example. In the connectors having a two-point contact configuration, a contact of one connector is elastically deformable and is provided with a contacting portion for contacting a mating contact at its distal end portion and a planar abutting portion extending in a mating direction on its proximal side, and, similarly, a contact of the other connector is elastically deformable and is provided with a contacting portion for contacting a mating contact at its distal end portion and a planar abutting portion extending in the mating direction on its proximal side. When the male and female connectors are mated and connected to each other, the contacting portion of the contact of one connector is abutted against the abutting portion of the contact of the other connector (a first contact point), and the contacting portion of the contact of the other connector is abutted against the abutting portion of the contact of one connector (a second contact point). In such a two-point contact configuration, a portion of the contact of one connector that is more distal than the contacting portion becomes a stab, and a portion of the contact of the other connector that is more distal than the contacting portion becomes a stab. Therefore, the stab lengths remain unchanged even if the contacting positions deviate in the mating direction, and it is advantageous not to be affected by a deviation of the mating position.

### SUMMARY OF THE INVENTION

Incidentally, in the male-female mating type connectors having a two-point contact configuration disclosed in Japanese Laid-Open Patent Publication No. H04-269478 and Japanese Laid-Open Patent Publication No. 2015-35300, the contacts are made by bending and forming a sheet metal material cut in an elongated shape, have a rectangular cross-sectional shape, and are configured in such a manner that the contacting portion and the abutting portion are brought into surface contact or line contact with each other. In such a case where the contacts abut each other in surface contact or line contact with each other, a plurality of positions of contact points therebetween may occur or the positions vary, and therefore a problem here is that contact reliability is likely to be lower. In this case, the contact reliability can be enhanced, for example, by forming the contacting portion in a spherical shape and bringing it into point contact. A problem here, however, is that forming only the contacting portion in a spherical shape is a difficult process. It should be noted that this problem occurs not only in the connectors having a two-point contact configuration, but also to the connectors having a one-point contact configuration. Furthermore, when the male and female connectors are mated and connected to each other, the spherical contacting portions are abutted against each other and pass over each other in an initial stage of the mating. Since the spherical surfaces of the contacting portions are abutted against each other, the contacting portions easily act to force each other to deviate transversely (in a direction perpendicular to the mating direction), and a problem here is that connection stability is compromised.

In view of these problems, an object of the present invention is to provide a male-female mating type electrical connector in which, when male and female connectors are mated and connected to each other, their contacting portions are both brought into point contact so that contact reliability can be enhanced.

In order to achieve such an object, a male-female mating type electrical connector according to a first aspect of the present invention includes a first connector (for example, a plug connector PC in an embodiment) retaining a plurality of conductive first contacts (for example, plug-side signal contacts 80 in the embodiment) in an insulating first retaining member, and an second connector (for example, a receptacle connector RC in the embodiment) retaining a plurality of conductive second contacts (for example, receptacle-side signal contacts 50 in the embodiment) in an insulating second retaining member, each of the first contacts being abutted against and electrically connected to a corresponding one of the second contacts by mating the first retaining member and the second retaining member. In this male-female mating type electrical connector, the first contacts are each composed of an elongated plate member supported in a cantilevered manner by the first retaining member, extending forward in a mating direction, and being rectangular in cross section. The first contacts each have a first contacting portion (for example, a plug-signal-side contacting portion 86 in the embodiment) at a distal end portion, a face of the first contacting portion on a side in which the first contact contacts the second contact having an arcuate cross-sectional shape and protruding toward the side in which the first contact contacts the second contact. The first contacts each have a first abutting portion (for example, a plug-signal-side abutting portion 85 in the embodiment) extending backward in the mating direction from the first contacting portion, a face of the first abutting portion on the side in the first contact contacts the second contact having an arcuate cross-sectional shape. Further, the second contacts are each composed of an elongated plate member supported in a cantilevered manner by the second retaining member, extending forward in the mating direction, and being rectangular in cross section. The second contacts each have an second contacting portion (for example, a receptacle-signal-side contacting portion 56 in the embodiment) at a distal end portion, a face of the second contacting portion on a side in which the second contact contacts the first contact having a planar shape and protruding toward the side in which the second contact contacts the first contact. The second contacts each have an second abutting portion (for example, a receptacle-signal-side abutting portion 55 in the embodiment) extending backward in the mating direction from the second contacting portion, a face of the second abutting portion on the side in which the second contact contacts the first contact having a planar shape.

A male-female mating type electrical connector according to a second aspect of the present invention includes a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member. In this male-female mating type electrical connector, the first contacts are each composed of an elongated plate member supported in a cantilevered manner by the first retaining member, extending forward in a mating direction, and being rectangular in cross section. The first contacts each have a first contacting portion at a distal end portion, a face of the first contacting portion on a side in which the first contact contacts the second contact having a planar shape and protruding toward the side in which the first contact contacts the second contact. The first contacts each have a first abutting portion extending backward in the mating direction from the first contacting portion, a face of the first abutting portion on the side in which the first contact contacts the second contact having an arcuate cross-sectional shape. Further, the second contacts are each composed of an elongated plate member supported in a cantilevered manner by the second retaining member, extending forward in the mating direction, and being rectangular in cross section. The second contacts each have an second contacting portion at a distal end portion, a face of the second contacting portion on a side in which the second contact contacts the first contact having a planar shape and protruding toward the side in which the second contact contacts the first contact. The second contacts each have an second abutting portion extending backward in the mating direction from the second contacting portion, a face of the second abutting portion on the side in which the second contact contacts the first contact having an arcuate cross-sectional shape.

In the male-female mating type electrical connector according to the first and second aspects of the present invention, it is preferred that, when the first retaining member and the second retaining member are mated to each other, the first contacting portion and the second contacting portion protrude in a direction at a right angle to the mating direction and in a direction approaching each other, be abutted against each other, be elastically deformed, and pass over each other, and that the first contacting portion be abutted against the second abutting portion under an elastic force, and the second contacting portion be abutted against the first abutting portion under an elastic force.

A male-female mating type electrical connector according to a third aspect of the present invention includes a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member. In this male-female mating type electrical connector, the first contacts are each composed of an elongated plate member supported in a cantilevered manner by the first retaining member, extending forward in a mating direction, and being rectangular in cross section. The first contacts each have a first contacting portion at a distal end portion, a face of the first contacting portion on a side in which the first contact contacts the second contact having an arcuate cross-sectional shape and protruding toward the side in which the first contact contacts the second contact. The first contacts each have an elastic arm portion extending backward in the mating direction from the first contacting portion. The second contacts are each composed of an elongated plate member supported by the second retaining member, extending in the mating direction, and being rectangular in cross section, and have an second abutting portion, a face of the second abutting portion on a side in which the second contact contacts the first contact having a planar shape.

A male-female mating type electrical connector according to a fourth aspect of the present invention includes a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member. In this male-female mating type electrical connector, the first contacts are each composed of an elongated plate member supported in a cantilevered manner by the first retaining member, extending forward in a mating direction, and being rectangular in cross section. The first contacts each have a first contacting portion at a distal end portion, a face rectangular in cross section of the first contacting portion on a side in which the first contact contacts the second contact protruding in a curved shape toward the side in which the first contact contacts the second contact. The first contacts each have an elastic arm portion extending backward in the mating direction from the first contacting portion. The second contacts each have an second abutting portion extending in the mating direction, a face of the second abutting portion on a side in which the second contact contacts the first contact having an arcuate cross-sectional shape.

In the male-female mating type electrical connector according to any one of the above aspects of the present invention, it is preferred that the first contacts and the second contacts are contacts that function as signal contacts for transmitting electrical signals.

In the male-female mating type electrical connector according to any one of the above aspects of the present invention, it is preferred that the first contacts and the second contacts are contacts that function as power-supply contacts for transmitting electric power.

According to the first aspect of the present invention, the first contacts each have a first contacting portion at a distal end portion, a face of the first contacting portion on a side in which the first contact contacts the second contact having an arcuate cross-sectional shape and protruding, and the first contacts each have a first abutting portion extending backward in the mating direction from the first contacting portion, a face of the first abutting portion on the side in which the first contact contacts the second contact having an arcuate cross-sectional shape. Further, the second contacts each have an second contacting portion at a distal end portion, a face of the second contacting portion on a side in which the second contact contacts the first contact having a planar shape and protruding, and the second contacts each have an second abutting portion extending backward in the mating direction from the second contacting portion, a face of the second abutting portion on the side in which the second contact contacts the first contact having a planar shape. Therefore, when the first retaining member and the second retaining member are mated to each other, the first contacting portion is abutted against the second abutting portion under an elastic force, and the second contacting portion is abutted against the first abutting portion under an elastic force. The first contact and the second contact can be thus brought into two-point contact with each other. Further, at this time, the first contacting portion having an arcuate cross-sectional shape and protruding toward the side in which the first contact contacts the second contact is abutted against the second abutting portion having a planar shape, and thus they come into point contact with each other, whereas the second contacting portion having an arcuate cross-sectional shape and protruding toward the side in which the second contact contacts the first contact is abutted against the first abutting portion having a planar shape, and thus they also come into point contact with each other. Since both the two contacting portions can be brought into point contact, contact reliability is enhanced.

In addition, according to the second aspect of the present invention, the first contacts each have a first contacting portion at a distal end portions, a face of the first contacting portion on a side in which the first contact contacts the second contact having a planar shape and protruding, and the first contacts each have a first abutting portion extending backward in the mating direction from the first contacting portion, a face of the first abutting portion on the side in which the first contact contacts the second contact having an arcuate cross-sectional shape. Further, the second contacts each have an second contacting portion at a distal end portion, a face of the second contacting portion on a side in which the second contact contacts the first contact having a planar shape and protruding, and the second contacts each have an second abutting portion extending backward in the mating direction from the second contacting portion, a face of the second abutting portion on the side in which the second contact contacts the first contact having an arcuate cross-sectional shape. Therefore, when the first retaining member and the second retaining member are mated to each other, the first contacting portion is abutted against the second abutting portion under an elastic force, and the second contacting portion is abutted against the first abutting portion under an elastic force. The first contact and the second contact can be thus brought into two-point contact with each other. Further, at this time, the first contacting portion having a planar shape and protruding toward the side in which the first contact contacts the second contact is abutted against the second abutting portion having an arcuate cross-sectional shape, and thus they come into point contact with each other, whereas the second contacting portion having a planar shape and protruding toward the side in which the second contact contacts the first contact is abutted against the first abutting portion having an arcuate cross-sectional shape, and thus they also come into point contact with each other. Since both the two contacting portions can be brought into point contact, contact reliability is enhanced.

According to the third aspect of the present invention, the first contacts each have a first contacting portion at a distal end portion, a face of the first contacting portion on a side in which the first contact contacts the second contact having an arcuate cross-sectional shape and protruding toward the side in which the first contact contacts the second contact, and the second contacts are each composed of an elongated plate member supported by the second retaining member, extending forward in the mating direction, and being rectangular in cross section, and have an second abutting portion, a face of the second abutting portion on a side in which the second contact contacts the first contact having a planar shape. This enables the first contacting portion and the second abutting portion to come into point contact with each other, and therefore contact reliability is enhanced.

According to the fourth aspect of the present invention, the first contacts each have a first contacting portion at a distal end portion, a face rectangular in cross section of the first contacting portion on a side in which the first contact contacts the second contact protruding in a curved shape toward the side in which the first contact contacts the second contact, and the second contacts each have an second abutting portion extending in the mating direction, a face of the second abutting portion on a side in which the second contact contacts the first contact having an arcuate cross-sectional shape. This enables the first contacting portion and the second abutting portion to come into point contact with each other, and therefore contact reliability is enhanced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIG. 1 is an external isometric view of a male-female mating type electrical connector in a mated state according to an embodiment of the present invention;

FIG. 2 is a cross-sectional view of the above male-female mating type electrical connector in a mated state;

FIG. 3 is an external isometric view of a receptacle connector RC constituting the above male-female mating type electrical connector;

FIG. 4 is an exploded isometric view of the above receptacle connector RC;

FIG. 5 is a right-to-left cross-sectional view of the above receptacle connector RC;

FIG. 6 is a front-to-rear cross-sectional view of the above receptacle connector RC;

FIG. 7 is an external isometric view of a plug connector PC constituting the above male-female mating type electrical connector;

FIG. 8 is an exploded isometric view of the above plug connector PC;

FIG. 9 is a right-to-left cross-sectional view of the above plug connector PC;

FIG. 10 is a front-to-rear cross-sectional view of the above plug connector PC;

FIG. 11A is a side view of a receptacle-signal-side connecting arm portion and a plug-signal-side connecting arm portion illustrating their abutted and electrically connected state, FIG. 11B is an enlarged side view of a receptacle-side signal contact, and FIG. 11C is an enlarged side view of a plug-side signal contact;

FIG. 12A is a side view of the receptacle-signal-side connecting arm portion, and FIG. 12B is an isometric view thereof;

FIG. 13A is an isometric view of the receptacle-signal-side connecting arm portion illustrating a cross section thereof taken along arrows X1-X1 in FIG. 12A, and FIG. 13B is an end view thereof;

FIG. 14A is an isometric view of the receptacle-signal-side connecting arm portion illustrating a cross section thereof taken along arrows X2-X2 in FIG. 12A, and FIG. 14B is an end view thereof;

FIG. 15A is a side view of the plug-side signal contact, and FIG. 15B is an isometric view thereof;

FIG. 16A is an isometric view of the plug-side signal contact illustrating a cross section thereof taken along arrows Y1-Y1 in FIG. 15A, and FIG. 16B is an end view thereof;

FIG. 17A is an isometric view of the plug-side signal contact illustrating a cross section thereof taken along arrows Y2-Y2 in FIG. 15A, and FIG. 17B is an end view thereof;

FIG. 18 is an enlarged isometric view of the receptacle-signal-side connecting arm portion and the plug-signal-side connecting arm portion illustrating their abutted and electrically connected state;

FIG. 19A is an isometric view of the receptacle-signal-side connecting arm portion and the plug-signal-side connecting arm portion in their abutted and electrically connected state illustrating their cross-sectional shapes in a region R1 in FIG. 18, and FIG. 19B is an end view thereof;

FIG. 20A is an isometric view of the receptacle-signal-side connecting arm portion and the plug-signal-side connecting arm portion in their abutted and electrically connected state illustrating their cross-sectional shapes in a region R2 in FIG. 18, and FIG. 20B is an end view thereof;

FIG. 21A is an isometric view of the receptacle-signal-side connecting arm portion and the plug-signal-side connecting arm portion illustrating their abutted state with the above receptacle connector RC and the above plug connector PC in their initial state of mating, and FIG. 21B is a cross-sectional isometric view thereof;

FIG. 22 is a cross-sectional view of abutting portions of the receptacle-signal-side connecting arm portion and the plug-signal-side connecting arm portion with the above receptacle connector RC and the above plug connector PC in their initial state of mating;

FIG. 23A is an isometric view of a receptacle-signal-side connecting arm portion and a plug-signal-side connecting arm portion illustrating their abutted state with a receptacle connector and a plug connector in their initial state of mating without application of the present invention, and FIG. 23B is a cross-sectional isometric view thereof; and

FIGS. 24A and 24B are cross-sectional views of abutting portions with a receptacle connector and a plug connector in their initial state of mating without application of the present invention.

### DESCRIPTION OF THE EMBODIMENTS

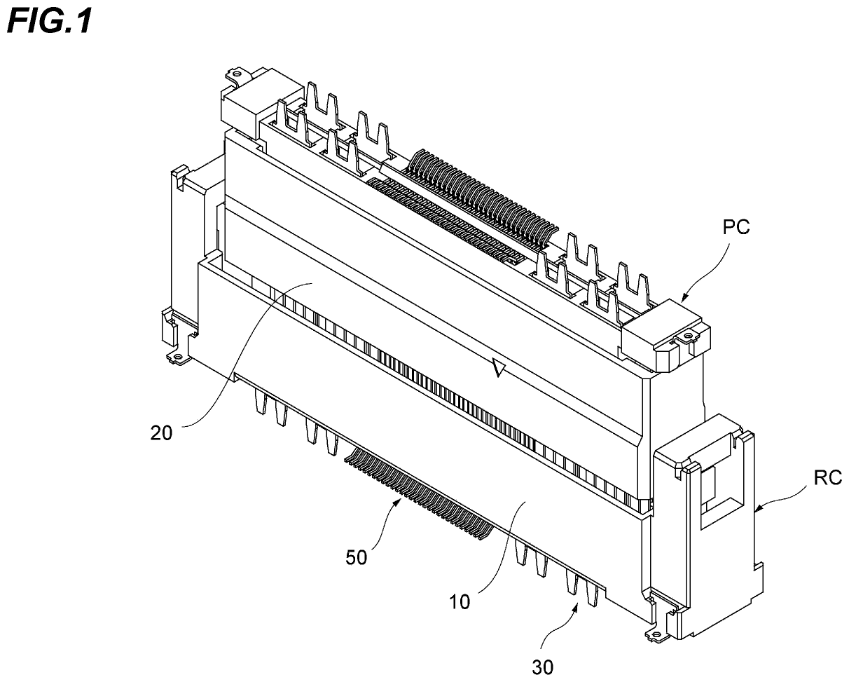

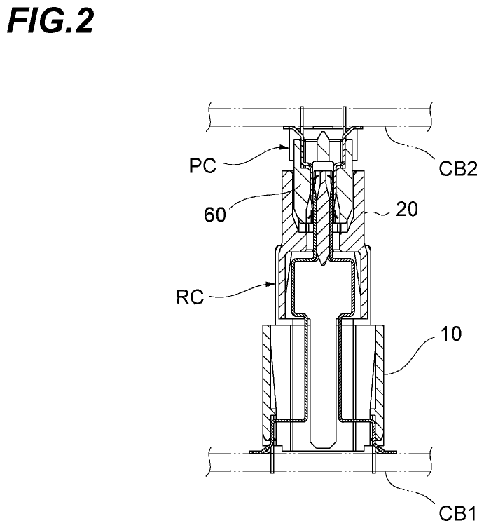

Preferred embodiments of the present invention will be described below with reference to the drawings. A male-female mating type electrical connector according to an embodiment of the present invention is shown in FIGS. 1 and 2. This electrical connector includes a receptacle connector RC and a plug connector PC, and both the connectors RC, PC are shown in a mated and connected state in FIGS. 1 and 2. As shown in FIG. 2, the receptacle connector RC is configured to be mounted on a first circuit board CB1, the plug connector PC is configured to be mounted on a second circuit board CB2, and signal transmission and power transmission are performed between the first and second circuit boards CB1, CB2 via both the connectors RC, PC mated and connected as shown. The first connector and the second connector defined in claims respectively correspond to either the receptacle connector RC or a plug connector PC.

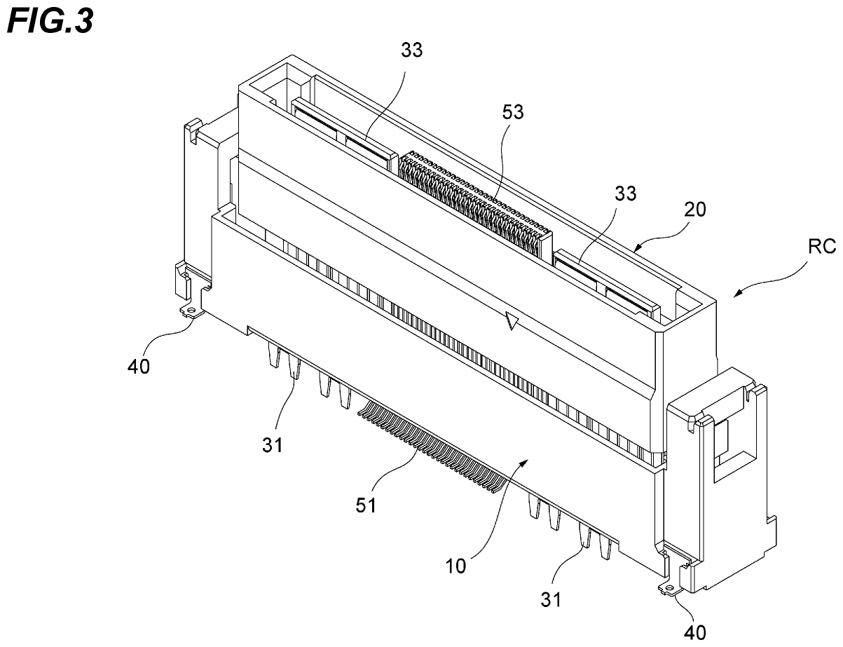

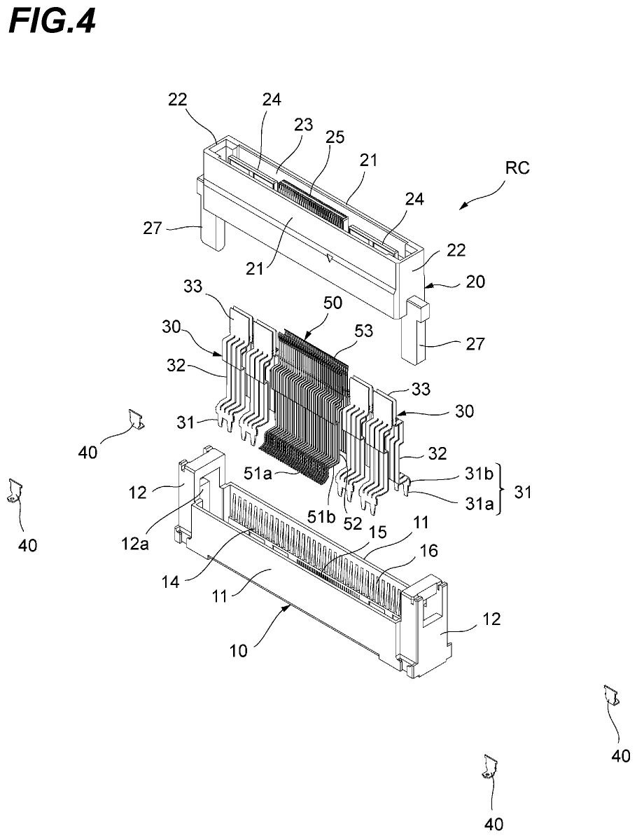

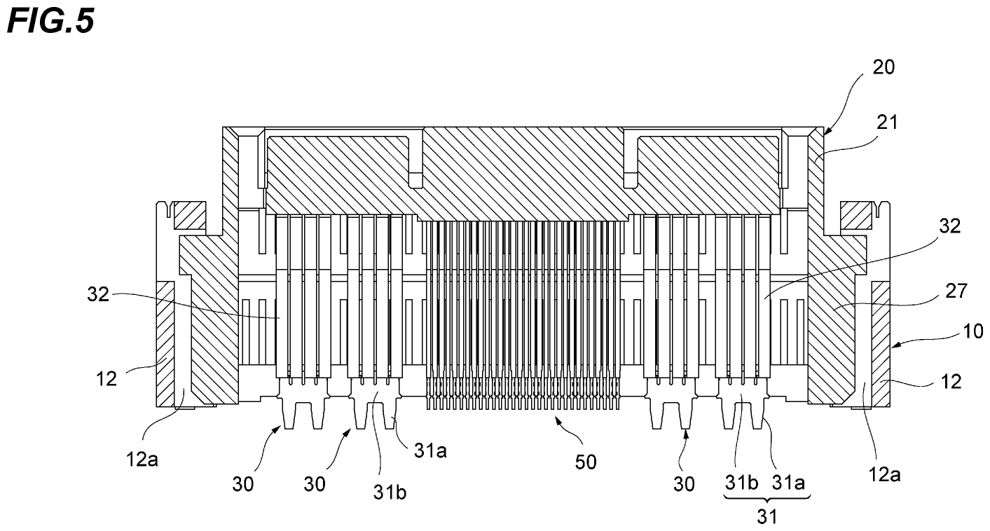

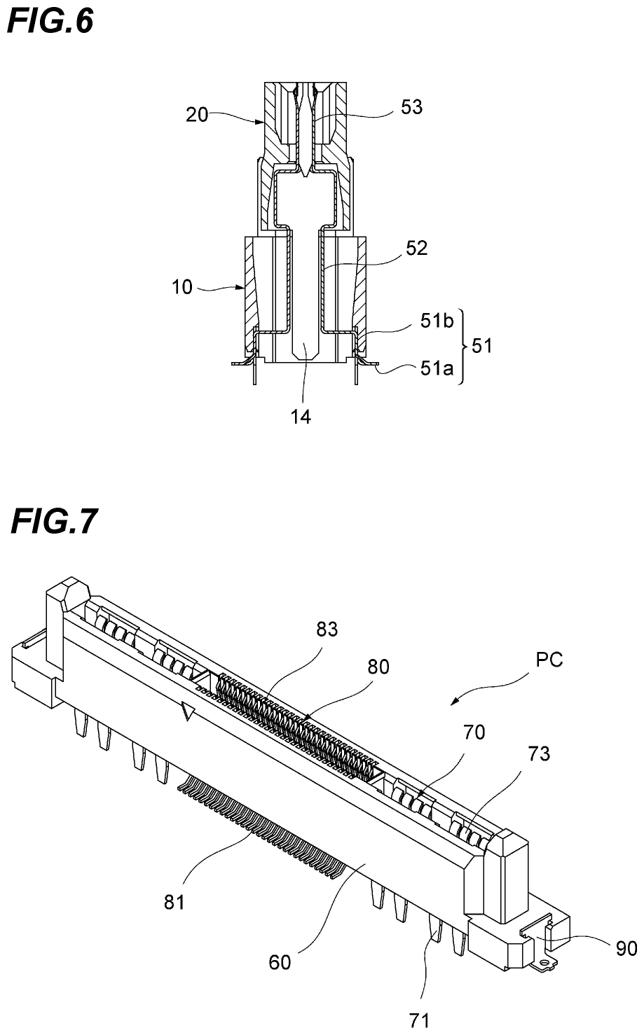

First, the receptacle connector RC will be described. The exterior of the receptacle connector RC is shown in FIG. 3, and this receptacle connector RC disassembled into its components is shown in FIG. 4. In addition, a right-to-left cross section and a front-to-rear cross section of the receptacle connector RC are shown in FIGS. 5 and 6, respectively. The receptacle connector RC includes a stationary housing 10 made of an insulating material, a movable housing 20 made of an insulating material, a large number of receptacle-side signal contacts 50 and receptacle-side power-supply contacts 30 made of a conductive material and attached to both the housings 10, 20 so as to bridge the housings 10, 20, and receptacle-side fixing brackets 40 made of a conductive material and attached to lower four corners of the stationary housing 10. The stationary housing 10 has a rectangular frame-like shape having a stationary-side space 14 vertically passing through the stationary housing 10, the shape being formed by front and rear walls 11, 11 and right and left walls 12, 12. In inner faces of the front and rear walls 11, 11 are formed a large number of vertically extending receptacle-side signal press-fitting grooves 15 used to press-fittingly retain receptacle-signal-side fixing portions 51b of the receptacle-side signal contacts 50, and a large number of vertically extending receptacle-side power-supply press-fitting grooves 16 used to press-fittingly retain receptacle-power-supply-side fixing portions 31b of the receptacle-side power-supply contacts 30. The right and left walls 12, 12 extend upward and each have a guide space 12a formed therein.

The movable housing 20 has a rectangular boxy shape with its top and bottom opened, the shape being formed by front and rear walls 21, 21 and right and left walls 22, 22. The right and left walls 22 each have a guide protrusion 27 at a lower portion, and the guide protrusion 27 is positioned in the guide space 12a to serve as a floating guide. A partition wall extending vertically and in a right-to-left direction is formed in a rectangular boxy inner space 23, and the inner space 23 is divided into front and rear spaces by the partition wall. The partition wall includes a signal-contact retaining partition wall 25 located in the middle, and power-supply-contact retaining partition walls 24, 24 located on the right and left of the signal-contact retaining partition wall 25. The signal-contact retaining partition wall 25 retains receptacle-signal-side connecting arm portions 53 of the receptacle-side signal contacts 50 in a cantilevered manner on its front and rear faces, and the power-supply-contact retaining partition walls 24 retain receptacle-power-supply-side contacting portions 33 of the receptacle-side power-supply contacts 30 on their front and rear faces.

The receptacle-side signal contacts 50 are each made by bending and forming an elongated plate member an elongated plate member made of a conductive material, and pairs of front and rear receptacle-side signal contacts 50 arranged symmetrically in a front-to-rear direction are arranged side by side in the right-to-left direction. A receptacle-signal-side base portion 51 of each receptacle-side signal contact 50 includes a receptacle-signal-side fixing portion 51b press-fitted in and fixed to the signal press-fitting groove 15, and a receptacle-signal-side mounting portion 51a extending transversely from a lower end of the receptacle-signal-side fixing portion 51b and surface-mounted on the first circuit board CB1. The receptacle-side signal contact 50 is provided with a receptacle-signal-side intermediate portion 52 extending upward from the receptacle-signal-side base portion 51 while bending in a cranked shape, and a receptacle-signal-side connecting arm portion 53 continuous with the top of the receptacle-signal-side intermediate portion 52. The receptacle-signal-side connecting arm portion 53 is so formed as to be fixed to and retained by the signal-contact retaining partition wall 25, and to extend further in a cantilevered manner. A configuration of the receptacle-signal-side connecting arm portion 53 will be described later. The receptacle-signal-side intermediate portion 52 has a shaped extending upward while bending in a cranked shape, and the receptacle-signal-side intermediate portion 52 is easily elastically deformable, and has a floating function of the movable housing 20 relative to the stationary housing 10.

The receptacle-side power-supply contacts 30 are each made by bending and forming a relatively wide plate member made of a conductive material, and pairs of front and rear receptacle-side power-supply contacts 30 arranged symmetrically in the front-to-rear direction are arranged side by side in the right-to-left direction, two pairs on each side of the above arrangement of the receptacle-side signal contacts 50. A receptacle-power-supply-side base portion 31 of the receptacle-side power-supply contact 30 includes a receptacle-power-supply-side fixing portion 31b press-fitted in and fixed to the receptacle-side power-supply press-fitting groove 16, and a receptacle-power-supply-side mounting portion 31a continuous with the receptacle-power-supply-side fixing portion 31b and extending downward to be mounted into a through-hole in the first circuit board CB1. The receptacle-side power-supply contact 30 is provided with a receptacle-power-supply-side intermediate portion 32 extending upward from the receptacle-power-supply-side base portion 31 while bending, and a receptacle-power-supply-side contacting portion 33 continuous with the top of the receptacle-power-supply-side intermediate portion 32. In each of the receptacle-side power-supply contact 30, as shown in FIG. 4, the receptacle-power-supply-side fixing portion 31 and the receptacle-power-supply-side contacting portion 33 are formed using the wide plate member as it is, whereas the receptacle-power-supply-side intermediate portion 32 is divided into a plurality of portions by a vertically extending slit, and the receptacle-power-supply-side intermediate portion 32 is easily elastically deformable, and has a floating function of the movable housing 20 relative to the stationary housing 10.

The receptacle connector RC thus configured is surface-mounted on the first circuit board CB1, as shown in FIG. 2. This surface-mounting is performed by soldering the receptacle-side fixing brackets 40 to a mount pattern on the first circuit board CB1. Simultaneously, the receptacle-signal-side mounting portions 51a of the receptacle-side signal contacts 50 are soldered to a pattern for signals, and the receptacle-power-supply-side mounting portions 31a of the receptacle-side power-supply contacts 30 are inserted into and joined to through-holes for power supply.

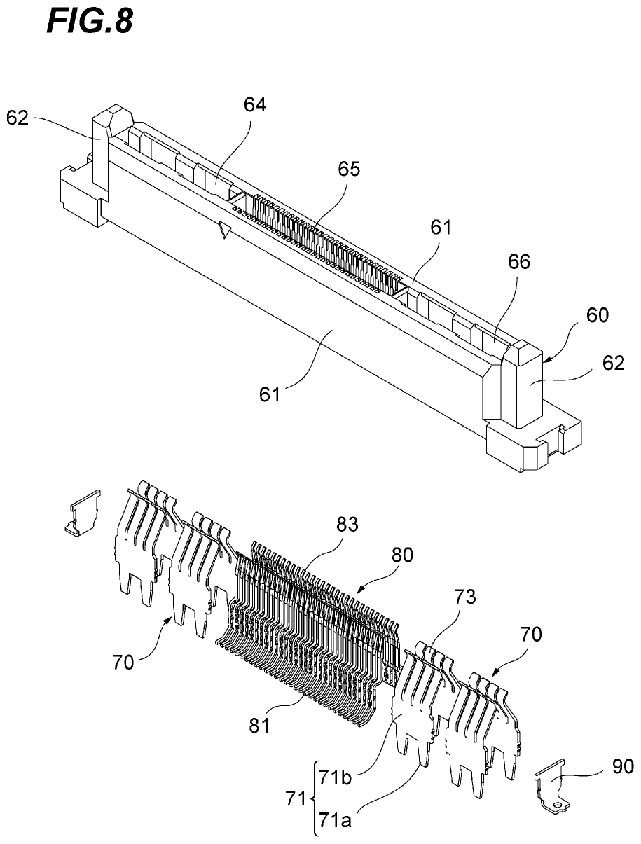

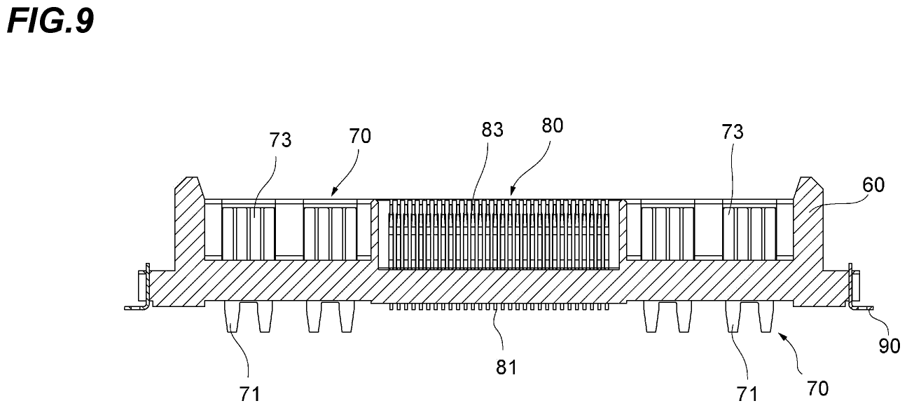

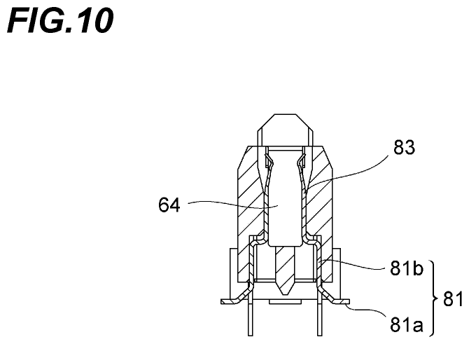

Next, the plug connector PC will be described. The exterior of the plug connector PC is shown in FIG. 7, and this plug connector PC disassembled into its components is shown in FIG. 8. In addition, a right-to-left cross section and a front-to-rear cross section of the plug connector PC are shown in FIGS. 9 and 10, respectively. The plug connector PC includes a retaining housing 60 made of an insulating material, a large number of plug-side signal contacts 80 and plug-side power-supply contacts 70 made of a conductive material and attached to the retaining housing 60, and plug-side fixing brackets 90 made of a conductive material and attached to right and left lower portions of the retaining housing 60. The retaining housing 60 has a rectangular frame-like shape having a vertically extending arrangement space 64, the shape being formed by front and rear walls 61, 61 and right and left walls 62, 62. In inner faces of the front and rear walls 61, 61 are formed a large number of vertically extending plug-side signal press-fitting grooves 65 used to press-fittingly retain plug-signal-side fixing portions 81b of the plug-side signal contacts 80, and vertically extending plug-side power-supply press-fitting grooves 66 used to press-fittingly retain plug-power-supply-side fixing portions 71b of the plug-side power-supply contacts 70.

The plug-side signal contacts 80 are each made by bending and forming an elongated plate member made of a conductive material, and pairs of front and rear plug-side signal contacts 80 arranged symmetrically in the front-to-rear direction are arranged side by side in the right-to-left direction. A plug-signal-side base portion 81 of each plug-side signal contact 80 includes a plug-signal-side fixing portion 81b press-fitted in and fixed to the plug-side signal press-fitting groove 65, and a plug-signal-side mounting portion 81a extending transversely from a lower end of the plug-signal-side fixing portion 81b and surface-mounted on the second circuit board CB2. The plug-side signal contact 80 further has a plug-signal-side connecting arm portion 83 continuous with the plug-signal-side base portion 81 and bending upward therefrom. The plug-signal-side connecting arm portion 83 is so formed as to be fixed to and retained by the plug-side signal press-fitting groove 65, and to extend further in a cantilevered manner. A configuration of the plug-signal-side connecting arm portion 83 will be described later.

The plug-side power-supply contacts 70 are each made by bending and forming a relatively wide plate member made of a conductive material, and pairs of front and rear plug-side power-supply contacts 70 arranged symmetrically in the front-to-rear direction are arranged side by side in the right-to-left direction, two pairs on each side of the above arrangement of the plug-side signal contacts 80. A plug-power-supply-side base portion 71 of the plug-side power-supply contact 70 includes a plug-power-supply-side fixing portion 71b press-fitted in and fixed to the plug-side power-supply press-fitting groove 66, and a plug-power-supply-side mounting portion 71a continuous with the plug-power-supply-side fixing portion 71b and extending downward to be mounted into a through-hole in the second circuit board CB2. The plug-side power-supply contact 70 further has a plug-power-supply-side contacting portion 73 continuous with the plug-power-supply-side base portion 71 and bending upward therefrom. The plug-power-supply-side contacting portion 73, as can be seen in FIG. 8, is so formed as to be opened and branched at its distal end.

The plug connector PC thus configured is surface-mounted on the second circuit board CB2, as shown in FIG. 2. This surface-mounting is performed by soldering the plug-side fixing brackets 90 to a mount pattern on the second circuit board CB2. Simultaneously, the plug-signal-side mounting portions 81a of the plug-side signal contacts 80 are soldered to a pattern for signals, and the plug-power-supply-side mounting portions 71a of the plug-side power-supply contacts 70 are inserted into and joined to through-holes for power supply.

The receptacle connector RC and the plug connector PC thus configured, as shown in FIGS. 1 and 2, are mated and connected to each other by inserting the retaining housing 60 of the plug connector PC into the movable housing 20 of the receptacle connector RC. When the receptacle connector RC and the plug connector PC are thus mated and connected to each other, the receptacle-signal-side connecting arm portions 53 of the receptacle-side signal contacts 50 and the plug-signal-side connecting arm portions 83 of the plug-side signal contacts 80 are abutted against and electrically connected to each other, and the receptacle-power-supply-side contacting portions 33 of the receptacle-side power-supply contacts 30 and the receptacle-power-supply-side contacting portions 73 of the plug-side power-supply contacts 70 are abutted against and electrically connected to each other.

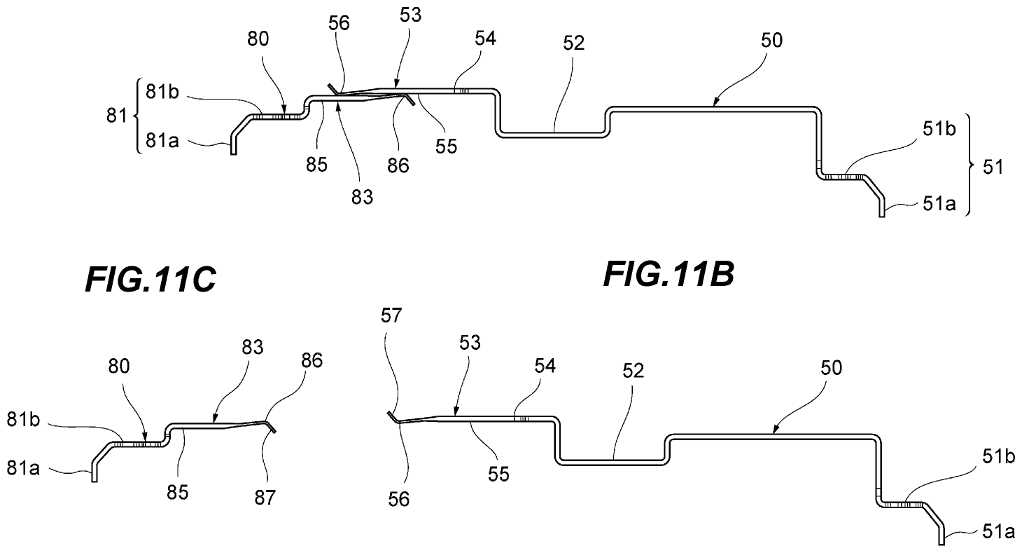

A configuration in which the receptacle-signal-side connecting arm portions 53 of the receptacle-side signal contacts 50 and the plug-signal-side connecting arm portions 83 of the plug-side signal contacts 80 are abutted against and electrically connected to each other will be described with reference to FIGS. 11A to 24B. In FIG. 11A is shown an abutted and connected state of the receptacle-side signal contact 50 and the plug-side signal contact 80 in a mated and connected state of the receptacle connector RC and the plug connector PC. In addition, the receptacle-side signal contact 50 is enlarged and shown in FIG. 11B, and the plug-side signal contact 80 is enlarged and shown in FIG. 11C.

As shown in FIG. 11B, the receptacle-signal-side connecting arm portion 53 of the receptacle-side signal contact 50 extends continuously with the receptacle-signal-side intermediate portion 52, and includes a receptacle-signal-side retained portion 54 fixed to and retained by the signal-contact retaining partition wall 25, a receptacle-signal-side abutting portion 55 extending in a cantilevered manner from the receptacle-signal-side retained portion 54, and a receptacle-signal-side contacting portion 56 protruding convexly toward an abutting side at a distal end of the receptacle-signal-side abutting portion 55. The receptacle-signal-side connecting arm portion 53 further has a receptacle-signal-side stab portion 57 more distal than the receptacle-signal-side contacting portion 56. In addition, as shown in FIG. 11C, the plug-signal-side connecting arm portion 83 of the plug-side signal contact 80 includes a plug-signal-side abutting portion 85 bending in a cranked shape from the plug-signal-side fixing portion 81b and extending in a cantilevered manner, and a plug-signal-side contacting portion 86 protruding convexly toward an abutting side at a distal end of the plug-signal-side abutting portion 85. The plug-signal-side connecting arm portion 83 further includes a plug-signal-side stab portion 87 more distal than the plug-signal-side contacting portion 86.

When the receptacle connector RC and the plug connector PC are mated and connected to each other, the receptacle-side signal contact 50 and the plug-side signal contact 80 are abutted against each other, as shown in FIG. 11A. At this time, the receptacle-signal-side contacting portion 56 is abutted against the plug-signal-side abutting portion 85 (this is referred to as a first contact point), and the plug-signal-side contacting portion 86 is abutted against the receptacle-signal-side abutting portion 55 (this is referred to as a second contact point). It should be noted that the receptacle-signal-side abutting portion 55 extending in a cantilevered manner and the plug-signal-side abutting portion 85 extending in a cantilevered manner are elastically deformable, and this elastic deformability causes a pressing force when the receptacle-signal-side contacting portion 56 and plug-signal-side contacting portion 86 at the first and second contact points come into contact with their contact partners (the plug-signal-side abutting portion 85 and the receptacle-signal-side abutting portion 55). At these contact points, in order to ensure contact reliability by bringing them into point contact, the shapes of the receptacle-signal-side contacting portion 56 and the receptacle-signal-side abutting portion 55 of the receptacle-side signal contact 50 and the shapes of the plug-signal-side contacting portion 86 and the plug-signal-side abutting portion 85 of the plug-side signal contact 80 are configured as will be described below.

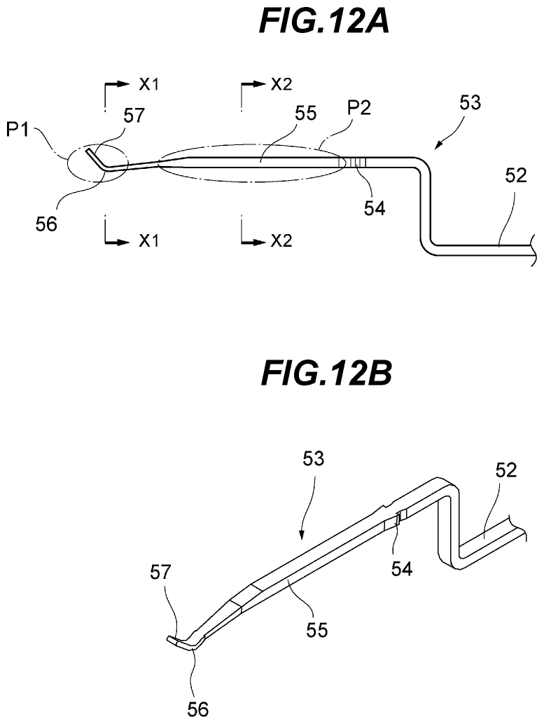

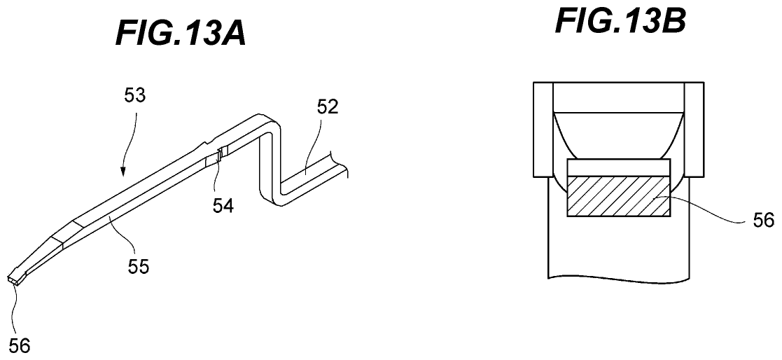

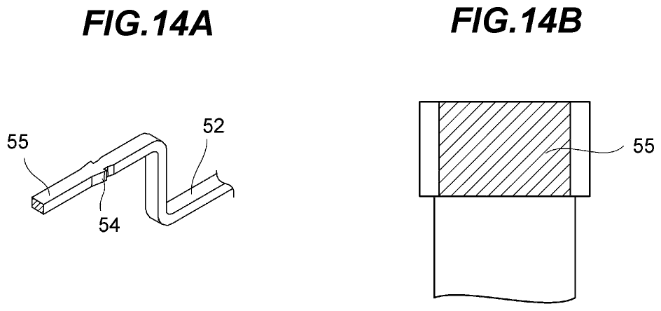

First, the receptacle-signal-side connecting arm portion 53 of the receptacle-side signal contact 50 is enlarged and shown in FIGS. 12A and 12B. FIG. 12A shows a side view of the receptacle-signal-side connecting arm portion 53, and FIG. 12B shows an isometric view thereof. As described above, the receptacle-side signal contact 50 is made by bending and forming an elongated plate member made of a conductive material, and is rectangular in cross section. Specifically, a cross-sectional shape of the receptacle-signal-side contacting portion 56 as viewed along arrows X1-X1 in the region of a circle P1 is rectangular, as shown in FIGS. 13A and 13B. The receptacle-signal-side contacting portion 56 is so bent and formed as to protrude convexly toward the abutting side, and its longitudinal shape (a shape in a side view) is arcuate. A cross-sectional shape of the receptacle-signal-side abutting portion 55 as viewed along arrows X2-X2 in the region of a circle P2 is also rectangular, as shown in FIGS. 14A and 14B. The receptacle-signal-side abutting portion 55 extends longitudinally straight, and its abutting-side face is planar.

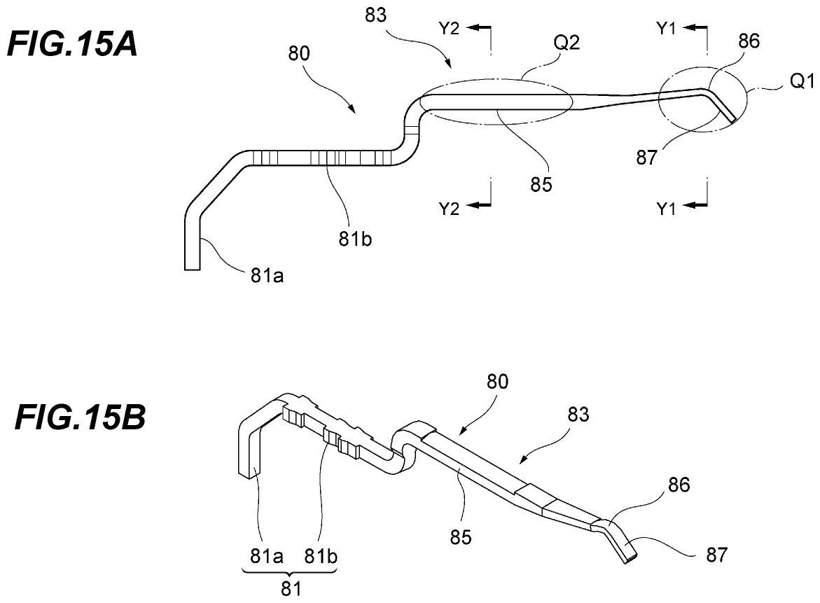

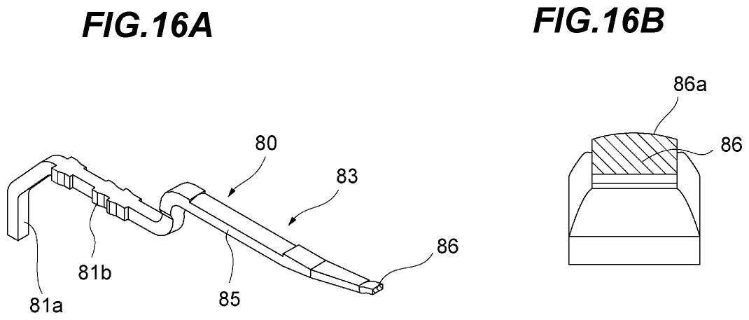

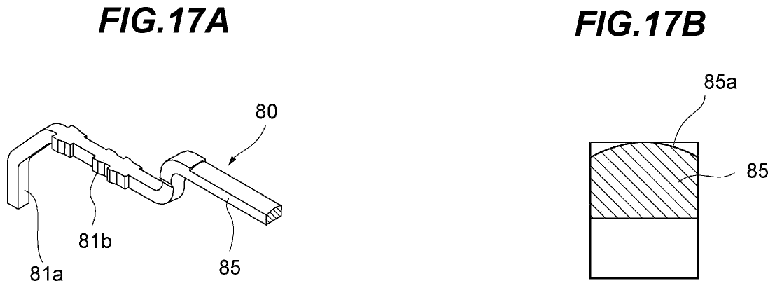

In addition, the plug-side signal contact 80 is shown in FIGS. 15A and 15B. FIG. 15A shows a side view of the plug-side signal contact 80, and FIG. 15B shows an isometric view thereof. As described above, the plug-side signal contact 80 is made by bending and forming an elongated plate member made of a conductive material, and is originally rectangular in cross section over its entire length. The plug-side signal contact 80, however, is formed in such a manner that a cross-sectional shape as viewed along arrows Y1-Y1 in the region of a circle Q1 including the plug-signal-side contacting portion 86 is arcuate on an abutting-side face (a face on a side in which the plug-signal-side contacting portion 86 abuts the receptacle-signal-side abutting portion 55), as shown in FIGS. 16A and 16B. That is, the abutting-side face of the elongated plate member rectangular in cross section is formed into a cylindrical shape arcuate in cross section (a semicylindrical shape), and is further so bent and formed as to protrude convexly toward the abutting side in a side view. Consequently, the plug-signal-side contacting portion 86 has a spherical convex shape. The plug-side signal contact 80 is also formed in such a manner that a cross-sectional shape of the plug signal-side abutting portion 85 as viewed along arrows Y2-Y2 in the region of a circle Q2 is arcuate on its abutting-side face (a face on a side in which the plug-signal-side abutting portion 85 abuts the receptacle-signal-side contacting portion 56), as shown in FIGS. 17A and 17B. That is, the abutting-side face of the elongated plate member rectangular in cross section is formed into a cylindrical shape arcuate in cross section and extending straight (a semicylindrical shape).

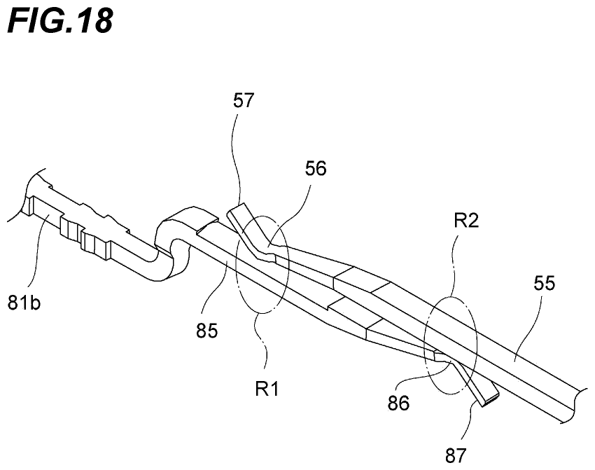

The receptacle-signal-side connecting arm portion 53 of the receptacle-side signal contact 50 and the plug-signal-side connecting arm portion 83 of the plug-side signal contact 80 thus configured are shown in FIG. 18 with their abutted and electrically connected portions enlarged. That is, FIG. 18 is an enlarged view of connections between the receptacle-signal-side connecting arm portion 53 and the plug-signal-side connecting arm portion 83 in FIG. 11A. As can be seen in FIG. 18, when the receptacle connector RC and the plug connector PC are mated and connected to each other, the receptacle-signal-side contacting portion 56 is abutted against the plug-signal-side abutting portion 85 (the first contact point shown in a circle R1), and the plug-signal-side contacting portion 86 is abutted against the receptacle-signal-side abutting portion 55 (the second contact point shown in a circle R2).

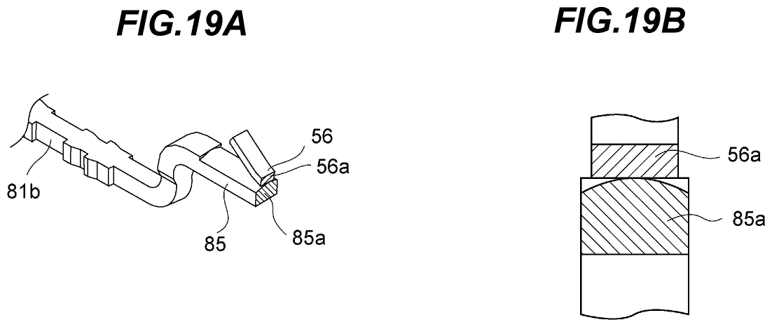

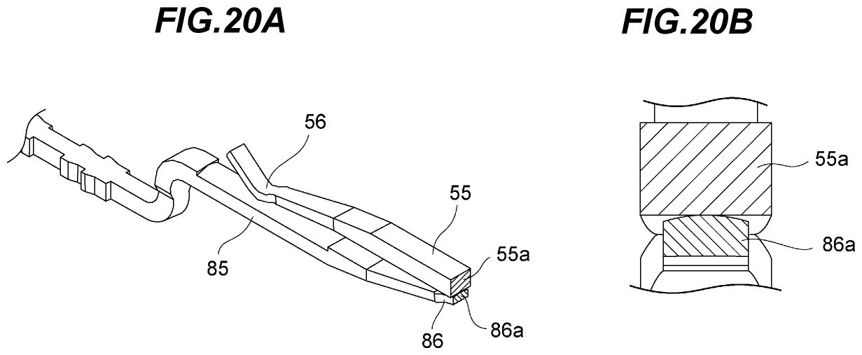

At the first contact point shown in the circle R1, as shown in FIGS. 19A and 19B, the receptacle-signal-side contacting portion 56 has a rectangular cross-sectional shape 56a, and has a curved shape in a side view curved convexly toward the abutting side. On the other hand, a cross-sectional shape 85a of the plug-signal-side abutting portion 85 is a cylindrical shape arcuate on an abutting-side face (a face on a side in which the plug-signal-side abutting portion 85 abuts the receptacle-signal-side contacting portion 56) and extending straight (a semicylindrical shape). These shapes cause the receptacle-signal-side contacting portion 56 and the plug-signal-side abutting portion 85 to come into point contact with each other at the first contact point. In addition, at the second contact point shown in the circle R1, as shown in FIGS. 20A and 20B, the receptacle-signal-side abutting portion 55 has a rectangular cross-sectional shape 55a, extends straight, and has a planar abutting-side face. On the other hand, the plug-signal-side contacting portion 86 has a spherical convex shape, as described above. These shapes similarly cause the receptacle-signal-side abutting portion 55 and the plug-signal-side contacting portion 86 to come into point contact with each other at the second contact point. Since the first and second contact points are both a point contact, high contact reliability is achieved. It should be noted that, a slight deviation of these first and second contact points due to dimensional tolerances or the like, which means a slight deviation of the mating position, does not affect the lengths of the stab portions 57, 87. Therefore, the effect of a deviation of the mating position on transmission signal characteristics is suppressed.

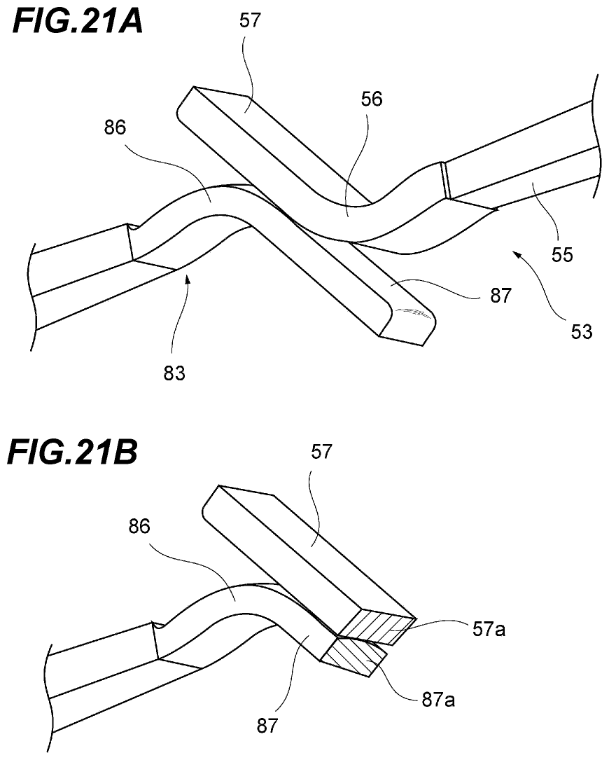

The receptacle-side signal contact 50 and the plug-side signal contact 80 thus configured also have an advantage when they are mated and connected to each other, and this advantage will be described with reference to FIGS. 21A to 24B. FIGS. 21A and 21B illustrate a state in which the receptacle-signal-side connecting arm portion 53 and the plug-signal-side connecting arm portion 83 are abutted against each other in an initial mating state when the receptacle connector RC and the plug connector PC are mated and connected to each other.

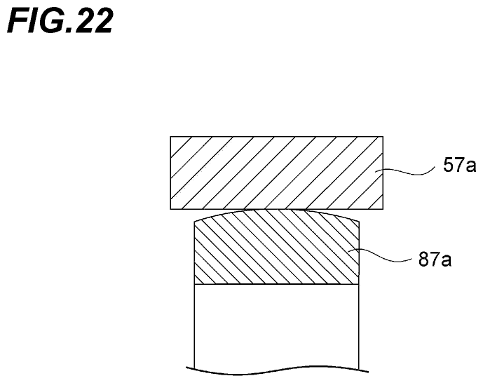

In the initial stage of mating, the receptacle-signal-side stab portion 57 and the plug-signal-side stab portion 87 are abutted against each other, and, while they are being pushed against each other along their slopes, the receptacle-signal-side connecting arm portion 53 and the plug-signal-side connecting arm portion 83 are elastically deformed. Then, the receptacle-signal-side contacting portion 56 and the plug-signal-side contacting portion 86 pass over each other into a connected state shown in FIG. 18. At this time, as shown in FIG. 22, the receptacle-signal-side contacting portion 56 and the receptacle-signal-side stab portion 57 have a rectangular cross-sectional shape 57a and are thus planar on their abutting faces, whereas the cross sections 87a of the plug-signal-side contacting portion 86 and the plug-signal-side stab portion 87 are arcuate on the abutting face side. This enables the receptacle-signal-side contacting portion 56 and the plug-signal-side contacting portion 86 to pass over each other smoothly into the connected state shown in FIG. 18.

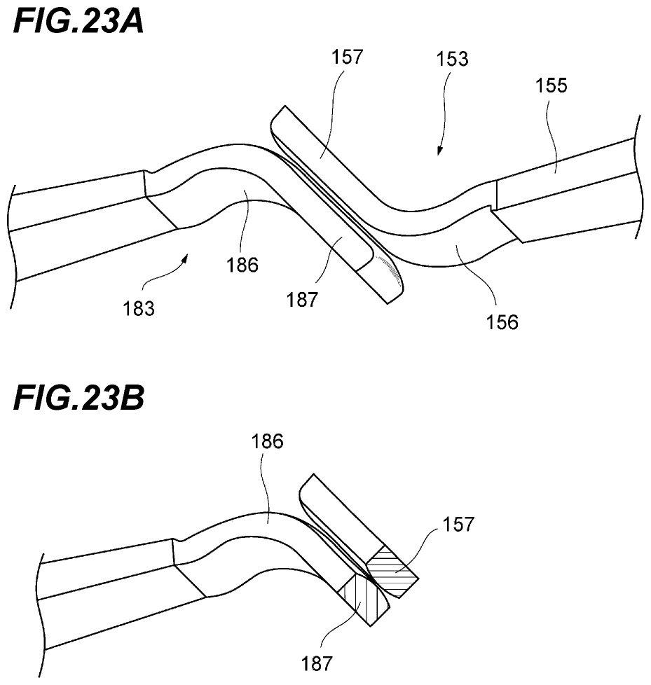

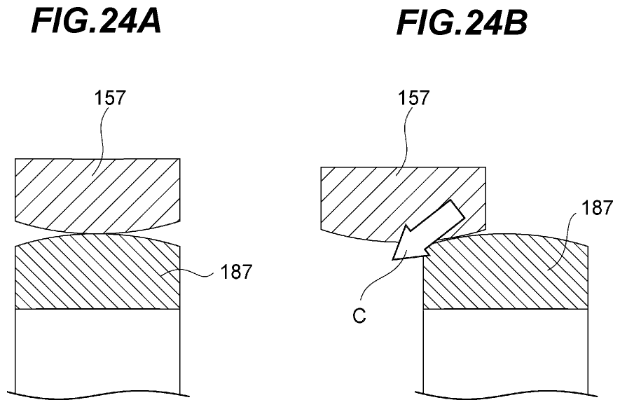

Incidentally, if the receptacle-signal-side contacting portion 56 and the plug-signal-side contacting portion 86 both have a spherical convex shape, and the receptacle-signal-side abutting portion 55 and the plug-signal-side abutting portion 85 both have a rectangular cross-sectional shape, they can still be brought into point contact with each other. An initial state of mating in such a configuration is shown in FIGS. 23A and 23B. A receptacle-signal-side stab portion 157 and a plug-signal-side stab portion 187 are abutted against each other, and while they are being pushed against each other along their slopes, a receptacle-signal-side connecting arm portion 153 and a plug-signal-side connection portion 183 are elastically deformed, and a receptacle-signal-side contacting portion 156 and a plug-signal-side contacting portion 186 pass over each other. In this case, however, as shown in FIG. 24A, the receptacle-signal-side stab portion 157 and the plug-signal-side stab portion 187, both of which have an arcuate abutting face, are abutted against each other. Therefore, a problem here is that, if their abutting positions deviate transversely, they are pushed transversely along the arcuate abutting faces and are positionally deviated, as indicated by an arrow C in FIG. 24B. Therefore, the configuration in which the receptacle-signal-side contacting portion 56 and the plug-signal-side contacting portion 86 both have a spherical convex shape, and the receptacle-signal-side abutting portion 55 and the plug-signal-side abutting portion 85 both have a rectangular cross-sectional shape, is undesirable, and thus is not a configuration to which the present invention applies.

Instead of the configuration described above, in a second embodiment, a receptacle-signal-side contacting portion and a plug-signal-side contacting portion may both have a shape obtained by bending a plate member rectangular in cross sectional, and a receptacle-signal-side abutting portion and a plug-signal-side abutting portion may both be formed in such a manner that an abutting-side face of an elongated plate member rectangular in cross section has a cylindrical shape arcuate in cross section and extending straight (a semicylindrical shape). That is, the plug-signal-side contacting portion 86 and the receptacle-signal-side contacting portion 56 may have the same shape, and the receptacle-signal-side abutting portion 55 and the plug-signal-side abutting portion 85 may have the same shape. This configuration can also achieve a point contact at both the first and second contact points. In the case of this configuration, a receptacle-signal-side stab portion and a plug-signal-side stab portion have a planar abutting face, and they can pass over each other smoothly and achieve mating.

A male-female mating type connector of a two-point contact type has been described above. The contact reliability of a male-female mating type connector of a one-point contact type, however, can also be enhanced by configuring it as follows so as to have a point-contact configuration. For example, with the receptacle-signal-side connecting arm portion 53 of the receptacle-side signal contact 50 left unchanged, the plug-signal-side connecting arm portion 83 of the plug-side signal contact 50 may have only the plug-signal-side abutting portion 85 without the plug-signal-side contacting portion 86 and the plug-signal-side stab portion 87. The plug-signal-side abutting portion 85 here may not be elastically deformable in a cantilevered manner. In the case of this configuration, the receptacle-signal-side contacting portion 56 rectangular in cross section and bent convexly in a side view is abutted against the plug-signal-side abutting portion 85 having a cylindrical shape having an arcuate cross-sectional shape and extending straight (a semicylindrical shape), and brought into one-point contact therewith. Since the abutting portion makes a point contact in this manner, high contact reliability can be ensured.

Conversely, with the plug-signal-side connecting arm portion 83 of the plug-side signal contact 80 left unchanged, the receptacle-signal-side connecting arm portion 53 of the receptacle-side signal contact 50 may have only the receptacle-signal-side abutting portion 55 without the receptacle-signal-side contacting portion 56 and the receptacle-signal-side stab portion 57. The receptacle-signal-side abutting portion 55 here may not be elastically deformable in a cantilevered manner. In this case, the plug-signal-side contacting portion 86 formed in a spherical shape by convexly bending a plate member arcuate in cross section is abutted against and brought into point contact with the receptacle-signal-side abutting portion 55 rectangular in cross section, extending straight, and having a planar abutting face. Since the abutting portion makes a point contact in this manner, high contact reliability can be ensured.

The above-described connection configurations of the receptacle-side signal contact 50 and the plug-side signal contact 80 of the receptacle connector RC and the plug connector PC may be applied to a connection configuration of the receptacle-side power-supply contact 30 and the plug-side power-supply contact 70. In addition, though the above receptacle connector RC has been configured as a floating type connector, the receptacle connector RC may be a connector other than a floating type one.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This invention claims the benefit of Japanese Patent Application No. 2023-120680 which is hereby incorporated by reference.

### EXPLANATION OF NUMERALS AND CHARACTERS

RC Receptacle connector
PC Plug connector
10 Stationary housing
15 Receptacle-side signal press-fitting groove
16 Receptacle-side power-supply press-fitting groove
20 Movable housing
24 Power-supply contact retaining partition wall
25 Signal contact retaining partition wall
30 Receptacle-side power-supply contact
31 Receptacle-power-supply-side base portion
31a Receptacle-power-supply-side mounting portion
31b Receptacle-power-supply-side fixing portion
32 Receptacle-power-supply-side intermediate portion
33 Receptacle-power-supply-side contacting portion
40 Receptacle-side fixing bracket
50 Receptacle-side signal contact
51 Receptacle-signal-side base portion
51a Receptacle-signal-side mounting portion
51b Receptacle-signal-side fixing portion
52 Receptacle-signal-side intermediate portion
53 Receptacle-signal-side connecting arm portion
54 Receptacle-signal-side retained portion
55 Receptacle-signal-side abutting portion
56 Receptacle-signal-side contacting portion
57 Receptacle-signal-side stab portion
60 Retaining housing
65 Plug-side signal press-fitting groove
66 Plug-side power-supply press-fitting groove
70 Plug-side power-supply contact
71 Plug-power-supply-side base portion
71a Plug-power-supply-side mounting portion
71b Plug-power-supply-side fixing portion
73 Plug-power-supply-side contacting portion
80 Plug-side signal contact
81 Plug-signal-side base portion
81a Plug-signal-side mounting portion
81b Plug-signal-side fixing portion
83 Plug-signal-side connecting arm portion
85 Plug-signal-side abutting portion
86 Plug-signal-side contacting portion
87 Plug-signal-side stab portion
90 Plug-side fixing bracket

What is claimed is:

1. A male-female mating type electrical connector comprising a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member, wherein
the first contacts are each composed of an elongated plate member supported in a cantilevered manner by the first retaining member, extending forward in a mating direction, and being rectangular in cross section,
the first contacts each have a first contacting portion at a distal end portion, a face of the first contacting portion on a side in which the first contact contacts with the second contact having an arcuate cross-sectional shape and protruding toward the side in which the first contact contacts with the second contact,
the first contacts each have a first abutting portion extending backward in the mating direction from the first contacting portion, a face of the first abutting portion on the side in which the first contact contacts with the second contact having an arcuate cross-sectional shape,
the second contacts are each composed of an elongated plate member supported in a cantilevered manner by the second retaining member, extending forward in the mating direction, and being rectangular in cross section,
the second contacts each have an second contacting portion at a distal end portion, a face of the second contacting portion on a side in which the second contact contacts the first contact having a planar shape and protruding toward the side in which the second contact contacts the first contact, and
the second contacts each have an second abutting portion extending backward in the mating direction from the second contacting portion, a face of the second abutting portion on the side in which the second contact contacts the first contact having a planar shape.

2. The male-female-mating type electrical connector according to claim 1, wherein
when the first retaining member and the second retaining member are mated to each other,
the first contacting portion and the second contacting portion protrude in a direction at a right angle to the mating direction and in a direction approaching each other, are abutted against each other, are elastically deformed, and pass over each other, and
the first contacting portion is abutted against the second abutting portion under an elastic force, and the second contacting portion is abutted against the first abutting portion under an elastic force.

3. The male-female mating type electrical connector according to claim 1, wherein the first contacts and the second contacts are contacts that function as signal contacts for transmitting electrical signals.

4. The male-female mating type electrical connector according to claim 1, wherein the first contacts and the second contacts are contacts that function as power-supply contacts for transmitting electric power.

5. A male-female mating type electrical connector comprising a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member, wherein
the first contacts are each composed of an elongated plate member supported in a cantilevered manner by the first retaining member, extending forward in a mating direction, and being rectangular in cross section,
the first contacts each have a first contacting portion at a distal end portion, a face of the first contacting portion on a side in which the first contact contacts the second contact having a planar shape and protruding toward the side in which the first contact contacts the second contact,
the first contacts each have a first abutting portion extending backward in the mating direction from the first contacting portion, a face of the first abutting portion on the side in which the first contact contacts the second contact having an arcuate cross-sectional shape,
the second contacts are each composed of an elongated plate member supported in a cantilevered manner by the second retaining member, extending forward in the mating direction, and being rectangular in cross section,
the second contacts each have an second contacting portion at a distal end portion, a face of the second contacting portion on a side in which the second contact contacts the first contact having a planar shape and protruding toward the side in which the second contact contacts the first contact, and
the second contacts each have an second abutting portion extending backward in the mating direction from the second contacting portion, a face of the second abutting portion on the side in which the second contact contacts the first contact having an arcuate cross-sectional shape.

6. The male-female-mating type electrical connector according to claim 5, wherein
when the first retaining member and the second retaining member are mated to each other,
the first contacting portion and the second contacting portion protrude in a direction at a right angle to the mating direction and in a direction approaching each other, are abutted against each other, are elastically deformed, and pass over each other, and
the first contacting portion is abutted against the second abutting portion under an elastic force, and the second contacting portion is abutted against the first abutting portion under an elastic force.

7. The male-female mating type electrical connector according to claim 5, wherein the first contacts and the second contacts are contacts that function as signal contacts for transmitting electrical signals.

8. The male-female mating type electrical connector according to claim 5, wherein the first contacts and the second contacts are contacts that function as power-supply contacts for transmitting electric power.

9. A male-female mating type electrical connector comprising a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member, wherein
the first contacts are each composed of an elongated plate member supported in a cantilevered manner by the first retaining member, extending forward in a mating direction, and being rectangular in cross section,
the first contacts each have a first contacting portion at a distal end portion, a face of the first contacting portion on a side in which the first contact contacts the second contact having an arcuate cross-sectional shape and protruding toward the side in which the first contact contacts the second contact,
the first contacts each have an elastic arm portion extending backward in the mating direction from the first contacting portion, and
the second contacts are each composed of an elongated plate member supported by the second retaining member, extending in the mating direction, and being rectangular cross section, and have an second abutting portion, a face of the second abutting portion on a side in which the second contact contacts the first contact having a planar shape.

10. The male-female mating type electrical connector according to claim 9, wherein the first contacts and the second contacts are contacts that function as signal contacts for transmitting electrical signals.

11. The male-female mating type electrical connector according to claim 9, wherein the first contacts and the second contacts are contacts that function as power-supply contacts for transmitting electric power.

12. A male-female mating type electrical connector comprising a first connector retaining a plurality of conductive first contacts in an insulating first retaining member, and an second connector retaining a plurality of conductive second contacts in an insulating second retaining member, each of the first contacts being abutted against and electrically connected to a corresponding one of the second contacts by mating the first retaining member and the second retaining member, wherein
the first contacts are each composed of an elongated plate member supported in a cantilevered manner by the first retaining member, extending forward in a mating direction, and being rectangular in cross section,
the first contacts each have a first contacting portion at a distal end portion, a face rectangular in cross section of the first contacting portion on a side in which the first contact contacts the second contact protruding in a curved shape toward the side in which the first contact contacts the second contact,
the first contacts each have an elastic arm portion extending backward in the mating direction from the first contacting portion, and
the second contacts each have an second abutting portion extending in the mating direction, a face of the second abutting portion on a side in which the second contact contacts the first contact having an arcuate cross-sectional shape.

13. The male-female mating type electrical connector according to claim 12, wherein the first contacts and the second contacts are contacts that function as signal contacts for transmitting electrical signals.

14. The male-female mating type electrical connector according to claim 12, wherein the first contacts and the second contacts are contacts that function as power-supply contacts for transmitting electric power.
